(19) United States
(12) Patent Application Publication
(10) Pub. No.: US 2006/0276920 A1
(43) Pub. Date: Dec. 7, 2006

(54) Portable music player

(76) Inventor: Stephen Yim Wah Leung, Hong Kong (CN)

Correspondence Address: SEYFARTH SHAW LLP, 131 S. DEARBORN ST., SUITE2400, CHICAGO, IL, 60603-5803, US

(21) Appl. No.: 11/439,825

(22) Filed: May 23, 2006

Related U.S. Application Data
(60) Provisional application No. 60/683,887, filed on May 23, 2005.

(51) Int. Cl. G06F 17/00

(52) U.S. Cl. 700/94

(57) ABSTRACT

A portable audio player including a housing, at least one interface connected to the housing and a storage medium contained in the housing. The storage medium being adapted to store at least one audio file such as a song downloaded from the internet or a personal computer. The portable audio player including a controller contained in the housing. The controller is in communication with the interface and includes at least one parameter which is configurable by a user, where the parameter controls the operation of the interface.

### PRIORITY CLAIM

This application claims priority to and the benefit of U.S. Provisional Application Ser. No. 60/683,887, filed May 23, 2005, the entire contents of which are incorporated herein.

### BACKGROUND

Portable music players are prevalent throughout many parts of society. Typically, these devices are expensive and geared toward adults. If adults want to provide their children with portable music players, they must give them one of the standard adult oriented players. This can present a problem, however, because these players do not provide the adult with any control over the musical content used in the player or over the manner in which the player is used.

Thus, what is needed is a portable music player that allows adults to control how it is used.

### SUMMARY

In one aspect, this application discloses system. The system includes a portable audio player and an article. One or more processes are embedded in the article that allow a user to control the content and the functionality of the portable audio player. The portable audio player in one example includes a memory, a controller, and at least one interface that controls at least one function of the music player. The memory is adapted to hold a number of audio files. The controller controls the at least one interface. The controller is configurable such that a user can define the values of one or more parameters governing the use of the interface. The controller also governs the transfer of audio files to the memory.

The article includes at least one computer-readable signal-bearing medium. Means in the medium stores audio files in a library. Means in the medium receives requests to add audio files to the library. Means in the medium validates whether the request originates from an authorized user. Means in the medium transfers the audio files to the library if the request originates from an authorized user.

One embodiment provides a portable audio player including a housing, at least one interface connected to the housing and a storage medium contained in the housing. The storage medium being adapted to store at least one audio file such as a song downloaded from the internet or a personal computer. The portable audio player including a controller contained in the housing. The controller is in communication with the interface and includes at least one parameter which is configurable by a user, where the parameter controls the operation of the interface.

In an embodiment, the portable audio player includes a display connected to the housing.

In an embodiment, the display is a liquid crystal display.

In an embodiment, the parameter sets a limit on the number of audio files that can be stored in the storage medium.

In an embodiment, the parameter includes an access control feature which enables a user to control at least one of: volume, importation of audio files, and deletion of songs from the storage medium.

In an embodiment, the access control feature is activated upon acceptance of password inputted by an authorized user.

In an embodiment, the portable audio player includes at least one input, where the input is operable to control at least one of: song selection, song list selection, volume, playing of an audio file stored in the storage medium and stopping play of an audio file stored in the storage medium.

In an embodiment, the storage medium includes one of: a magnetic storage medium, an optical storage medium and an atomic storage medium.

In an embodiment, the portable audio player includes a hold button connected to the housing. The hold button is in communication with the controller and is operable to disable functioning of all the buttons.

Another embodiment provides a portable audio player including a housing, at least one interface connected to the housing and a storage medium contained in the housing. The storage medium is adapted to store at least one audio file. The portable audio player includes a controller contained in the housing, where the controller is in communication with the interface and includes at least one parental control parameter configurable by a parent to control operation of the interface. The portable audio player also includes an access control feature associated with the parental control parameter, where the access control feature is operable to enable an authorized user to access the parental control parameter.

In an embodiment, the portable audio player includes a display connected to the housing.

In an embodiment, the parameter sets a limit on the number of audio files that can be stored in the storage medium.

In an embodiment, the access control feature enables a user to control at least one of: volume, importation of audio files, and deletion of songs from the storage medium.

In an embodiment, the access control feature is activated upon acceptance of password inputted by an authorized user.

In an embodiment, the portable audio player includes at least one input, where the input is operable to control at least one of: song selection, song list selection, volume, playing of an audio file stored in the storage medium and stopping play of an audio file stored in the storage medium.

In an embodiment, the storage medium includes one of: a magnetic storage medium, an optical storage medium and an atomic storage medium.

In an embodiment, the portable audio player includes a hold button in communication with the controller, where the hold button is operable to disable functioning of all the buttons.

An advantage of the present invention is to provide a portable audio player which is configurable by an authorized user to restrict at least one function of the portable audio player

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIGS. 1-2 are elevated front perspective views of a portable audio player;

FIGS. 3-4 are elevated rear perspective views of the portable audio player of FIGS. 1-2;

FIGS. 5-6 are front elevated views if the portable audio player of FIGS. 1-4 with markings shown thereon;

FIGS. 7A-7B are compact discs that include software that can be utilized with a portable audio player, such as that shown in FIGS. 1-4;

FIGS. 8-9 are top plan views of the packaging of a portable audio player, such as that shown in FIGS. 1-4; and

FIGS. 10-17 are screenshots of the software that can be utilized with a portable audio player, such as that shown in FIGS. 1-4.

### DETAILED DESCRIPTION

The following detailed description of exemplary embodiments of a portable audio player and software will now be provided for illustrative purposes.

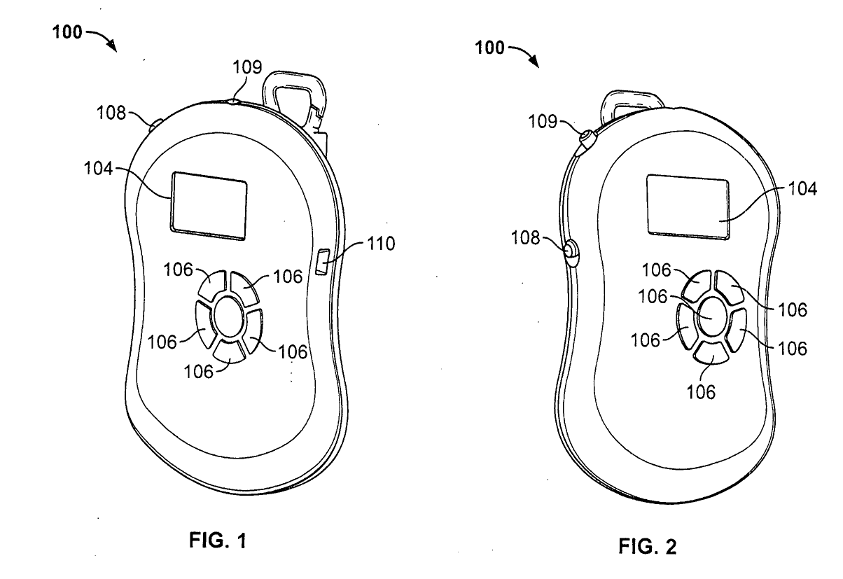

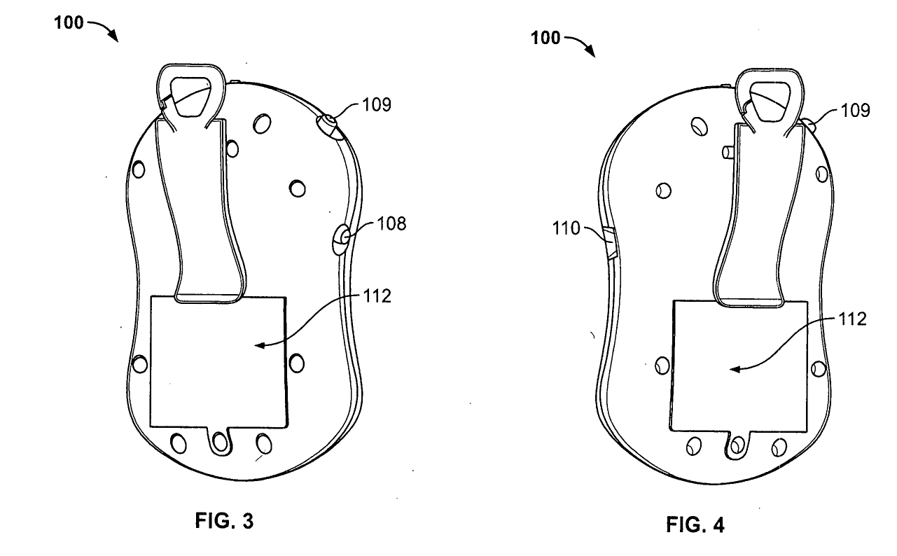

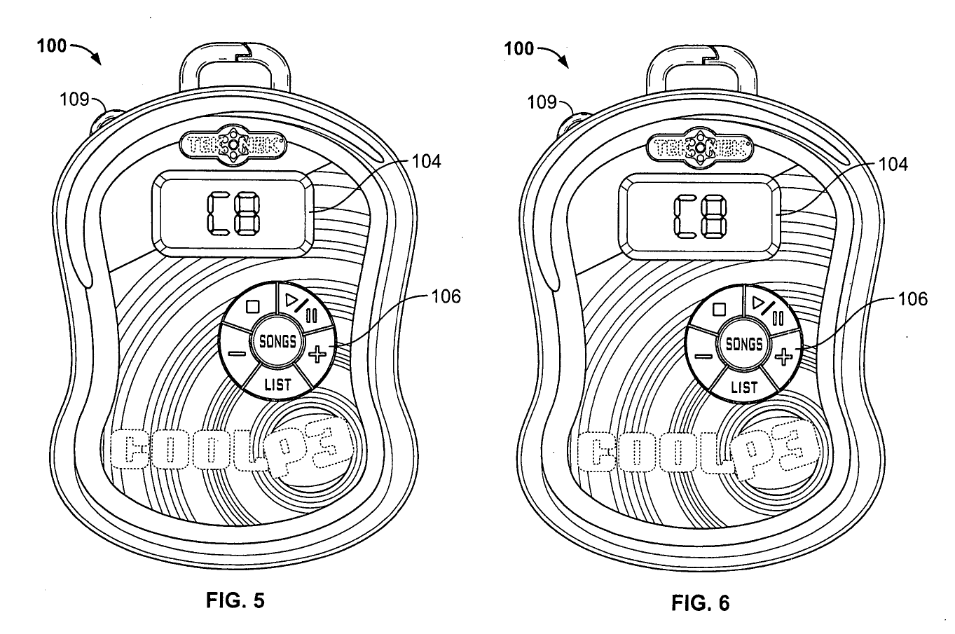

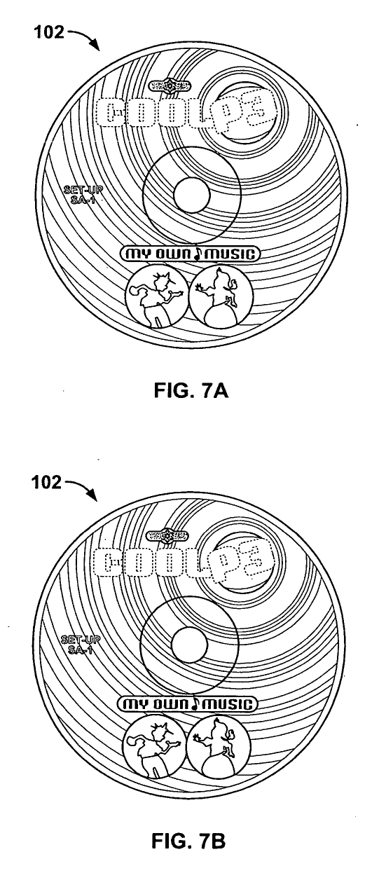

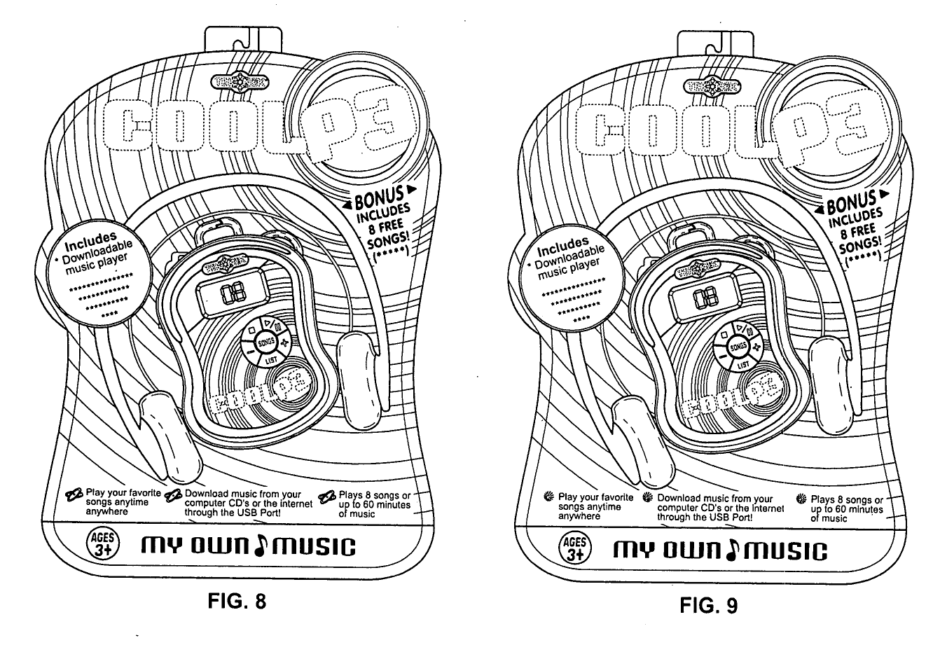

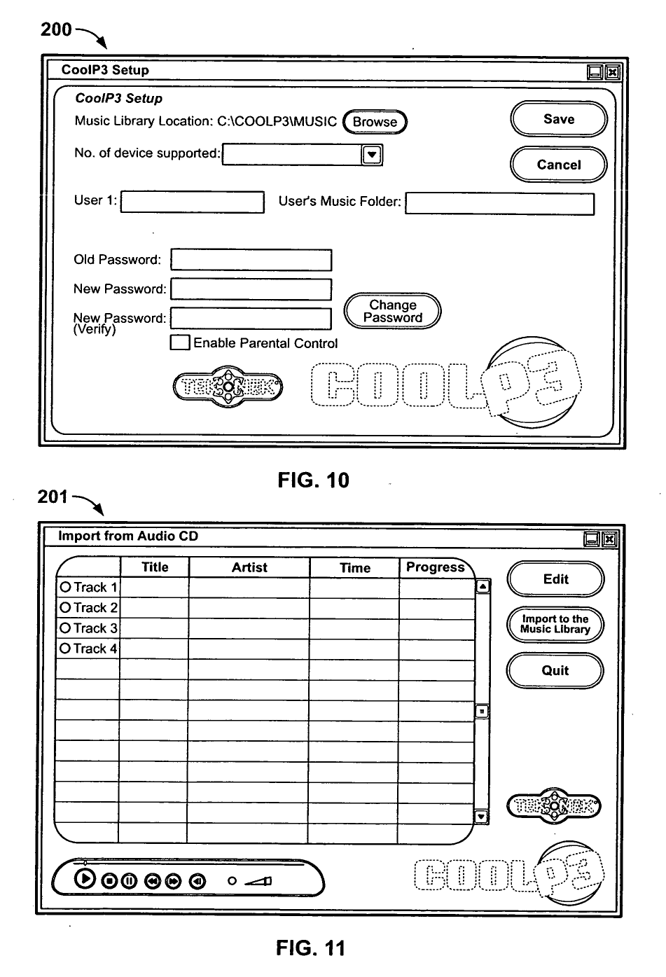

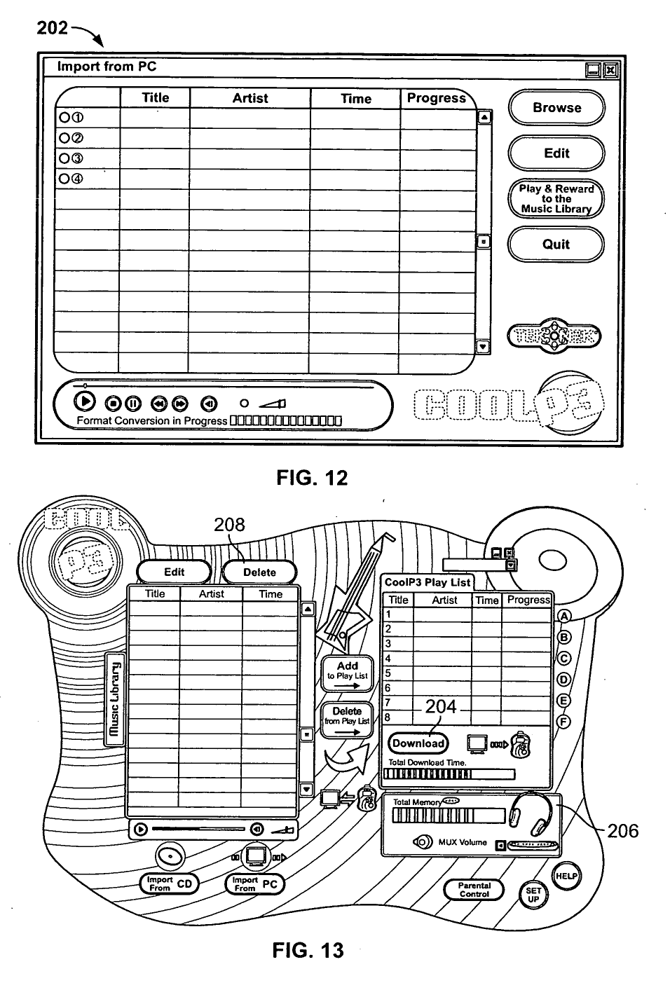

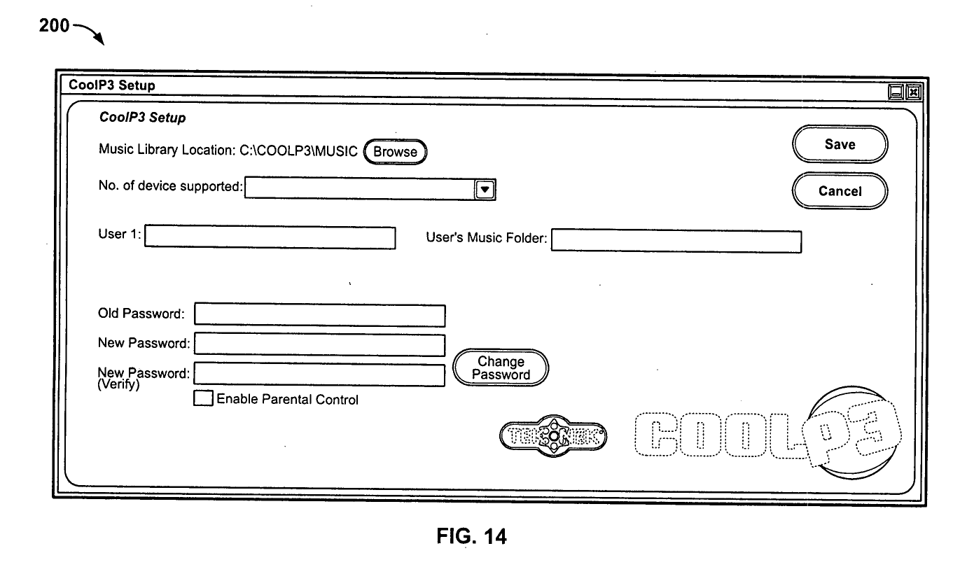

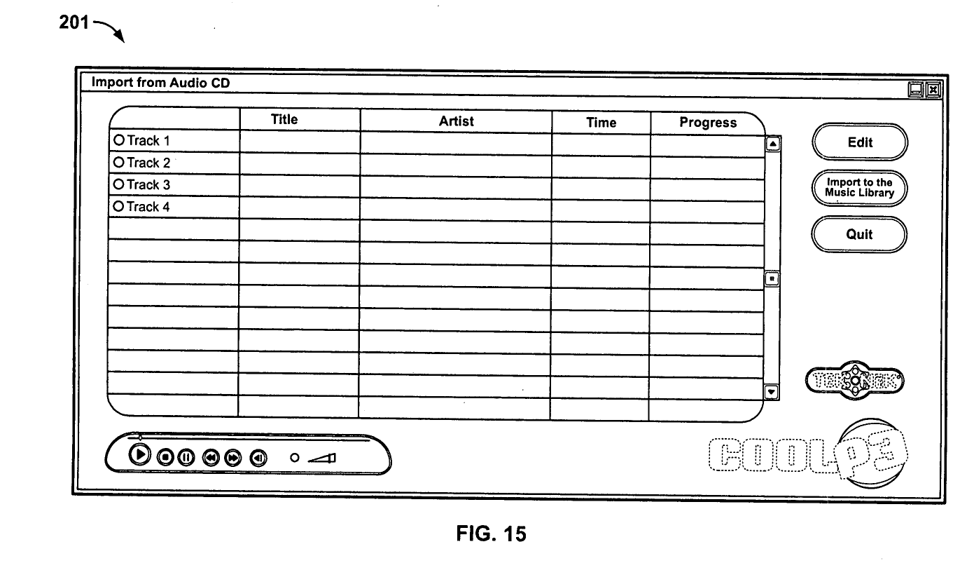

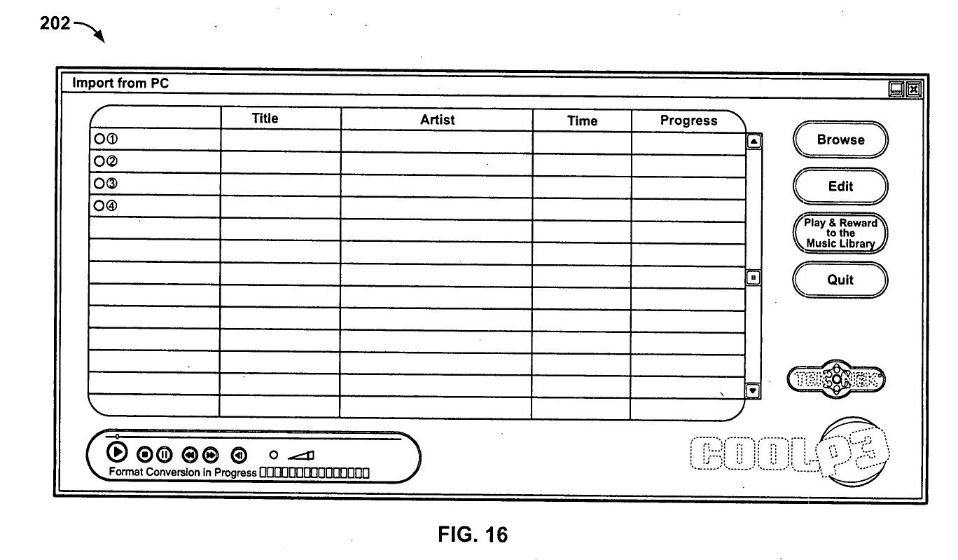

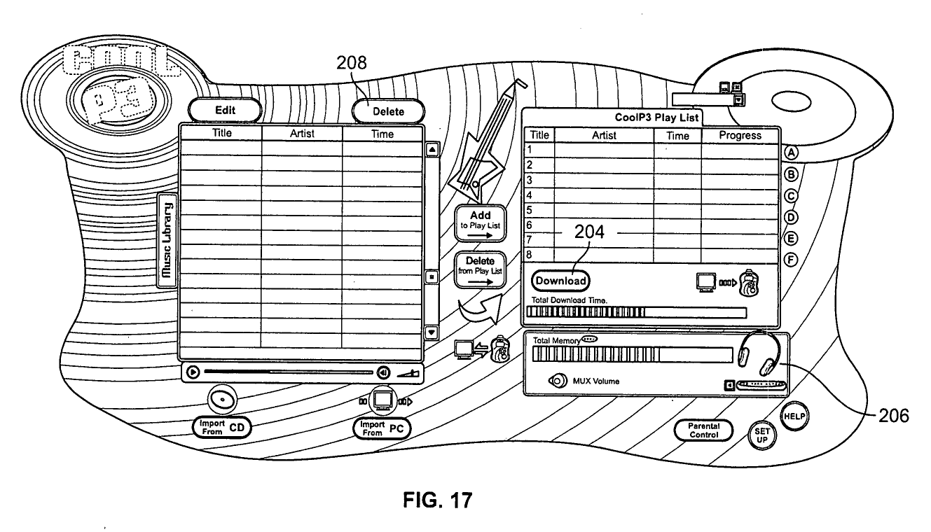

Referring to FIGS. 1-17, the portable audio player 100 in one example is designed to satisfy kids' need to have their own, user-friendly music player. Parents can choose to download songs from complimentary Compact Disc (CD) 102, other music CDs or from parent selected websites through personal computer (PC) into the player via a connecting interface cord, such as a USB or IEEE 1394.

An exemplary description of the hardware used in the portable audio player is now provided for illustrative purposes.

| | |
|---|---|
| DSP Chip | ×1 |
| 16 Mbytes NandFlash | ×1 (Samsung and Toshiba compatible) |
| LCD Drive | ×1 |
| USB Controller Chip | ×16 × 8 |
| Dot-matrix LCD (104) | ×1 |
| Push button (106) | ×6 |
| Song (for song selection) | |
| List (for song list selection) | |
| Vol up | |
| Vol down | |
| Play | |
| Stop | |
| On/Off slide switch (108) | ×2 |
| Key hold | |
| Power on/off | |
| Connection: USB Cable | |
| (1.2 M) (110) | |
| Download Speed 40% | |
| Operating Battery (112) | AAA × 3 |
| Headphone | ×1 |

−32 ohm, 20-20 kHz, 4 feet cable, 3.5 mm stereo plug nickel plated, foam ear pad

An exemplary description of the software used with the portable audio player is now provided for illustrative purposes.

The software used with the portable audio player in one example will operate on a computing device or system. A computing device in one example is a personal computer. In another example the computing device could be a workstation, a file server, a mainframe, a personal digital assistant (“PDA”), a mobile telephone, or a combination of these devices. In the case of more than one computing device, the multiple computing devices could be coupled together through a network.

A network in one example includes any network that allows multiple computing devices to communicate with each other (e.g., a Local Area Network (“LAN”), a Wide Area Network (“WAN”), a wireless LAN, a wireless WAN, the Internet, a wireless telephone network, etc.) In a further example, a network comprises a combination of the above mentioned networks. The computing device can be connected to the network through landline (e.g., T1, DSL, Cable, POTS) or wireless technology, such as that found on mobile telephones and PDA devices.

The computing device could include a plurality of components such as computer software and/or hardware components to carry out the process. A number of such components can be combined or divided. An exemplary component employs and/or comprises a series of computer instructions written in or implemented with any of a number of programming languages, as will be appreciated by those skilled in the art.

In one example, the software is embedded in an article including at least one computer-readable signal-bearing medium. One example of a computer-readable signal-bearing medium is a recordable data storage medium such as a magnetic, optical, and/or atomic data storage medium. In another example, a computer-readable signal-bearing medium is a modulated carrier signal transmitted over a network comprising or coupled with computing device or system, for instance, a telephone network, a local area network (“LAN”), the Internet, and/or a wireless network.

In one example, the software includes the following exemplary functionality:
1. Build up a “Music Library” by imported wave files. (default path=c:\coolp3\music for common access, users can customize this path)
2. In the Music Library, all imported wave files will be stripped down to Mono & 8k sampling rate WAV format.
3. In the Music Library, users can delete the imported files by press the delete button.
4. An embedded music player is used to preview the WAV files in the Music Library by double click or press the Play button.
5. There will be an “Import from CD” Pop-Up window (201) for select, preview and import songs from CD audio to the music library with Mono & 8k sampling rate WAV format after the “Import from CD” button from the main program has been clicked. The songs information such as song title, artist will be downloaded from the CDDB server and saved in the Music Library. An embedded music player is used in to preview the WAV files in the Music Library by double click them or press the Play button.
6. There will be an “Import from PC” Pop-Up window (202) to select, preview and import existing music files from PC to the music library with Mono & 8k sampling rate WAV format after the “Import from PC” button from the main program has been clicked. The song title and artist information will be read from the Header Tag of the Mp3 or WMA files and saved into the Music Library.
7. For each song in the music library & CoolP3 playlist, TITLE, ARTIST & TIME should be displayed and sorted by them in logical order. An index file or database is created to store that information.
8. Drag and Drop selected music from the Music Library to the CoolP3 play list. At the same time, WAV format should changed to A16 format automatically and show the progress bar during conversion. A Maximum of 8 songs for each Drag & Drop and give out “Too many songs selected” warning if too many songs are selected.
9. When the “Download” button (204) is pressed, the selected A16 format songs in the Play List will be downloaded to the CoolP3 player. A Maximum of 8 songs for each Download and give out “Too many songs selected” warning if too many songs are selected.
10. There will be a memory status bar (206) to show the usage of CoolP3 memory and the converting/downloading process.
11. There will be an access control feature displayed on a screen (200) to restrict the specific functionalities only access by parent or other users with permission by entering password. The specific functions included Maximum Volume Protection, import audio files & rip audio CD to the music library and deleting songs from the music library.
12. For the Access (Parental) Control feature, if the Password is lost or forgotten, users can reinitialize the program and the using the default code to gain access again.
13. There will be a Delete button (208) to remove the songs from the Music Library, CoolP3 Play list and the player.
14. CoolP3 ID will be added to the program. Different profiles will be created to store information such as Play List and Player Status for multi-CoolP3 users.
15. Avoid using “My Music Folder” if your PC is configured for multiple users to allow access to CoolP3 Music Library by all users. (Default Installation Directory=C:\CoolP3)

An exemplary method of using the system will now be described for illustrative purposes. The method includes the following steps:

(i) Power ON the player by Hardware Power ON/OFF switch (108). Opening animation will be played accompanied by an opening midi. Opening midi will be played ONCE and then stop animation and show.

(ii) Select the song list by pressing the “List”. Default list is list A if “List” button has not been pressed. Selected list will rotate in the manner of A→B→C . . . →F→A→B.

(iii) Select the Song Number by pressing the “songs” button. Default song is song number 1 if the “songs” button has not been pressed. Selected Song will rotate in the manner of 1→2→ . . . →8→1→2. The selected song can be viewed on the screen. The default song is Song number 1 of current side.

(iv) Play the song by pressing the “Play/Pause” button. There are eight sets of animations will be played when playing a song. When the 1 st song is being played, the 1st animation will be played. When the 2nd song is being played, the 2nd animation will be played. When the 8th song is being played, the 8th animation will be played. After the 8 sets of animations have been played once, for all the songs being played onward, one of the 8 sets of animations will be played at “Random”. Both of “stop” status and “pause” status, song selection is permitted.

(v) When the current song is finished, the next song in the same side will be played after some delay (˜3 s). Also the number of the song will be displayed on screen around 2 seconds. All of the songs in a song list are played in sequence. The player will not stop, until the last song (song 8) in the current side is finished.

(vi) To play a particular song (not following the song list), the following steps are performed: (a) Stop or pause the current song if a song is being played. (b) Change the list by pressing “List” button. (c) Change the song number to the desired song number by pressing “Songs” button. (d) Press the “Play” button to play the song.

(vii) To pause a Song, press the “Play/Pause” button. To resume a paused song, press the “Play/Pause” button. To skip the current song and jump to next song press the “songs” button (at this moment, the player is in stop status and the next song no. will be shown on the screen). Go to the next song by pressing the “play” button. When the player is idle for ˜3 minutes (i.e. a song is paused or stopped and no new song selection is made), player will be powered off ( sleep mode—power off animation will be played once). The player is started again by pressing the “Play” button (opening animation will be played accompanied by an opening midi). If a song is paused over 3 minutes, the player will enter sleep mode. By pressing “play”, the player is restarted and the paused song will be played again from the beginning.

(viii) By turning on the Key-hold (109), all the functional buttons will be disabled. A graphic indicating Key-Hold will be display for a few seconds. Volume can be dynamically changed at anytime and volume bar will be shown on screen, whenever the volume± is pressed. After 5 seconds with no action for volume control, the volume bar will be closed.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

The invention is claimed as follows:

1. A portable audio player comprising:
a housing;
at least one interface connected to the housing;
a storage medium contained in said housing, said storage medium adapted to store at least one audio file; and
a controller contained in said housing, said controller being in communication with said interface and including at least one parameter which is configurable by a user, said parameter controlling the operation of the interface.

2. The portable audio player of claim 1, which includes a display connected to the housing.

3. The portable audio player of claim 2, wherein the display is a liquid crystal display.

4. The portable audio player of claim 1, wherein said parameter sets a limit on the number of audio files that can be stored in said storage medium.

5. The portable audio player of claim 1, wherein said parameter includes an access control feature which enables a user to control at least one of: volume, importation of audio files, and deletion of songs from the storage medium.

6. The portable audio player of claim 5, wherein access control feature is activated upon acceptance of password inputted by an authorized user.

7. The portable audio player of claim 1, which includes at least one input, said input operable to control at least one of: song selection, song list selection, volume, playing of an audio file stored in the storage medium and stopping play of an audio file stored in the storage medium.

8. The portable audio player of claim 1, wherein said storage medium includes one of: a magnetic storage medium, an optical storage medium and an atomic storage medium.

9. The portable audio player of claim 1, which includes a hold button connected to said housing and in communication with the controller, said hold button operable to disable functioning of all the buttons.

10. A portable audio player comprising:
a housing;
at least one interface connected to the housing;
a storage medium contained in said housing, said storage medium adapted to store at least one audio file;
a controller contained in said housing, said controller being in communication with said interface and including at least one parental control parameter which is configurable by a parent to control operation of the interface; and
an access control feature associated with said parental control parameter, said access control feature operable to enable an authorized user to access said parental control parameter.

11. The portable audio player of claim 10, which includes a display connected to the housing.

12. The portable audio player of claim 10, wherein said parameter sets a limit on the number of audio files that can be stored in said storage medium.

13. The portable audio player of claim 10, wherein said access control feature enables a user to control at least one of: volume, importation of audio files, and deletion of songs from the storage medium.

14. The portable audio player of claim 13, wherein said access control feature is activated upon acceptance of password inputted by an authorized user.

15. The portable audio player of claim 10, which includes at least one input, said input operable to control at least one of: song selection, song list selection, volume, playing of an audio file stored in the storage medium and stopping play of an audio file stored in the storage medium.

16. The portable audio player of claim 10, wherein said storage medium includes one of: a magnetic storage medium, an optical storage medium and an atomic storage medium.

17. The portable audio player of claim 10, which includes a hold button in communication with the controller, said hold button operable to disable functioning of all the buttons.
